(19) United States
(12) Patent Application Publication
(10) Pub. No.: US 2012/0288314 A1
(43) Pub. Date: Nov. 15, 2012

(54) PRINTING DEVICE AND METHOD THEREOF

(75) Inventor: PO-CHUN CHEN, Tu-Cheng (TW)

(73) Assignee: HON HAI PRECISION INDUSTRY CO., LTD., Tu-Cheng (TW)

(21) Appl. No.: 13/324,097

(22) Filed: Dec. 13, 2011

(30) Foreign Application Priority Data
May 9, 2011 (TW) 100116230

(51) Int. Cl. B41J 11/42

(52) U.S. Cl. 400/582

(57) ABSTRACT

A printing device includes a paper tray for supporting paper, a paper delivering module, a control module connected to the paper delivering module, a printing module configured to print on one or more sheets of the paper, and a detecting module connected to the control module and the paper delivering module. The paper delivering module includes a paper delivering channel connected to the paper tray. The control module sends instructions to control the paper delivering module. The detecting module detects whether the paper pass through the channel one by one and the printing process may be halted if necessary. A printing method based upon the printing device is also disclosed.

### BACKGROUND

1. Technical Field

The present disclosure relates to printing devices and printing methods.

2. Description of Related Art

A printing device prints text and graphics on paper or other print media. The printing device usually includes a paper tray for holding paper and a paper delivering module for delivering paper to the paper tray via a paper outlet. However, two or more pieces of paper can sometimes adhere together by static electricity and delivered together to the paper tray.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of an embodiment of a printing device.

FIG. 2 is a detailed block diagram of a control module of the printing device of FIG. 1.

FIG. 3 is a detailed block diagram of a detecting module of the printing device of FIG. 1.

FIG. 4 is a view showing the positions of a light source and a light sensor of the detecting module of FIG. 3.

FIG. 5 is a flow chart of an embodiment of a printing method.

### DETAILED DESCRIPTION

The disclosure is illustrated by way of example and not by way of limitation. In the figures of the accompanying drawings, like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as in an EPROM. It will be appreciated that modules may comprise connected logic units, such as gates and flip-flops, and may also comprise programmable units, such as programmable gate arrays or processors. The modules described herein may be implemented as either software and/or hardware modules and may be stored in any type of computer-readable medium or other computer storage device.

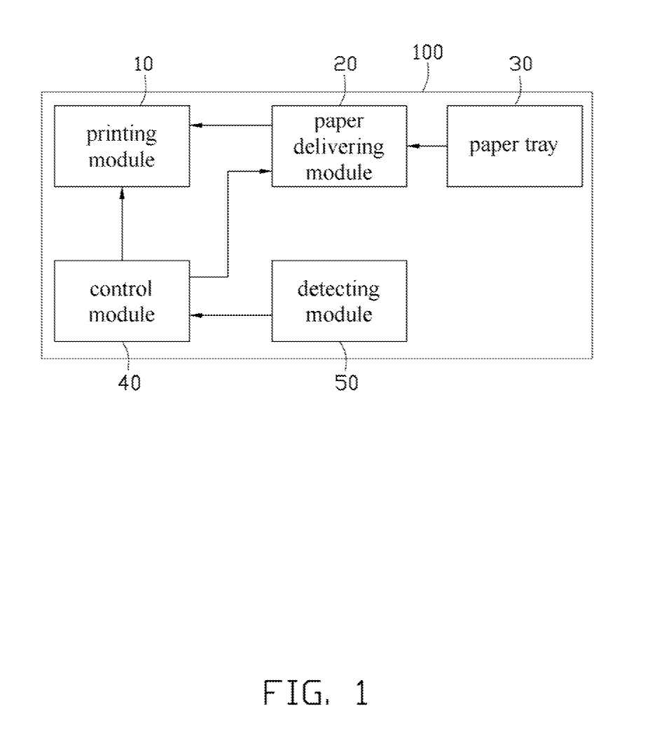

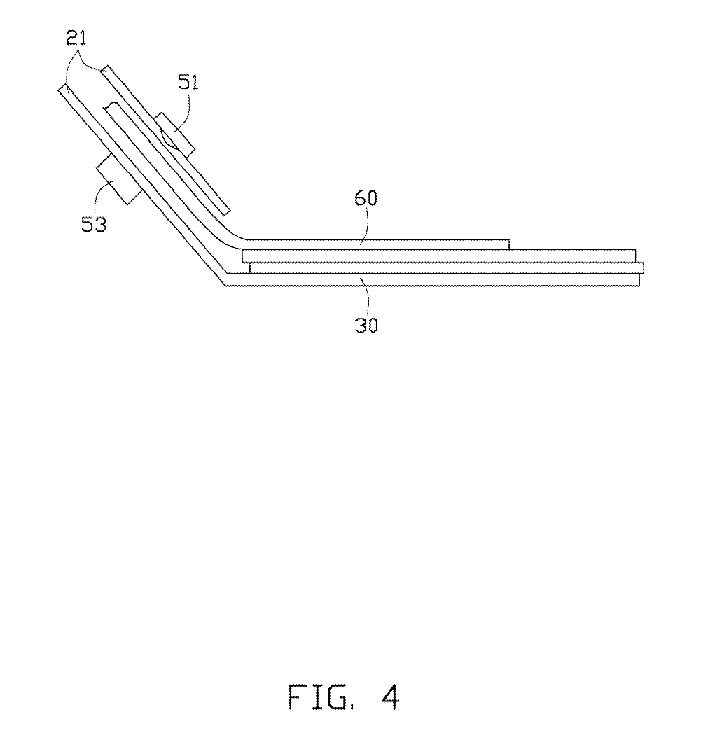

Referring to FIG. 1, an embodiment of a printing device 100 includes a printing module 10 configured to print text or graphics on print media (e.g., paper 60, shown in FIG. 4), a paper delivering module 20 configured to deliver paper 60 to the printing module 10, a paper tray 30 configured to hold paper 60 thereon for printing, a control module 40 configured to control a print process, and a detecting module 50 configured to detect if the paper delivering module 20 is delivering paper 60 one by one.

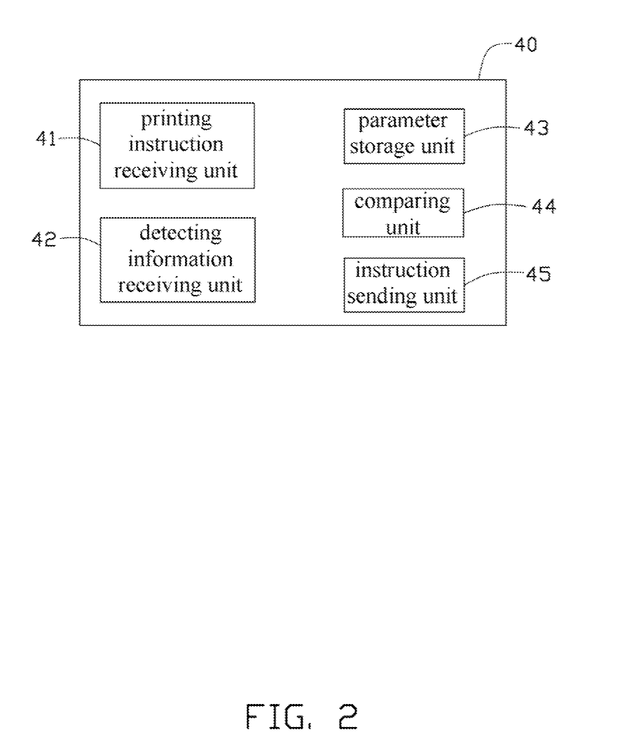

Referring to FIG. 2, the control module 40 includes a printing instruction receiving unit 41, a detecting information receiving unit 42, a parameter storage unit 43, a comparing unit 44, and an instruction sending unit 45. The printing instruction receiving unit 41 receives printing instructions sent from requesting terminals (e.g., computers). The detecting information receiving unit 42 receives information sent from the detecting module 50. The comparing unit 44 compares the information from the detecting module 50 with predetermined parameters stored in the parameter storage unit 43. The instruction sending unit 45 outputs instructions to the paper delivering module 20 to start or stop the paper delivering module 20.

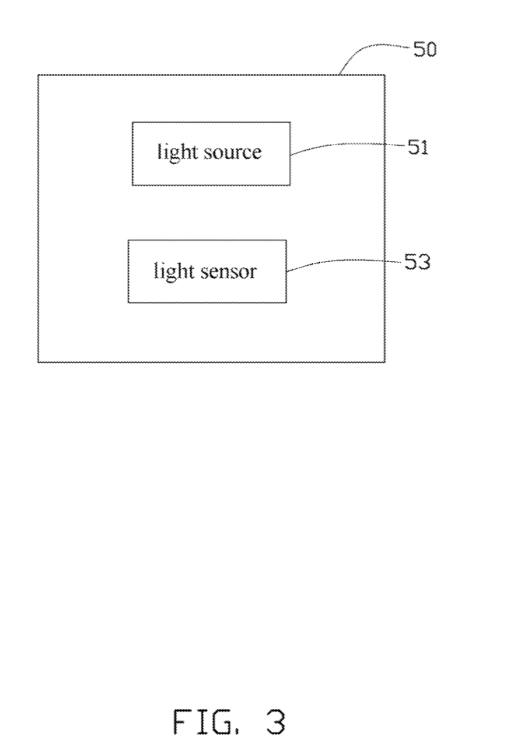

Referring to FIGS. 3 and 4, the detecting module 50 includes a light source 51 and a light sensor 53. The paper delivering module 20 includes a paper delivering channel 21 which connects to the paper tray 30. Paper 60 is placed on the paper tray 30. The light source 51 and the light sensor 53 are located at opposite sides of the paper delivering path 21. If there is no paper between the light source 51 and the light sensor 53 in the paper delivering path 21, the light sensor 53 senses a first light intensity and sends the first light intensity to the detecting information receiving unit 42. If one piece of paper 60 is between the light source 51 and the light sensor 53, the light sensor 53 can sense a second light intensity and send the second light intensity information to the detecting information receiving unit 42. In one embodiment, each paper 60 is slightly translucent and every paper 60 has about the same light translucency. Thus, the second light intensity is inevitably less than the first light intensity. If more than one piece of paper 60 simultaneously enters into the paper delivering path 21 and comes between the light source 51 and the light sensor 53, the light sensor 53 will sense a light intensity less than the second light intensity. Thus, the printing device 100 can determine that there is more than one sheet of paper entering into the paper delivering path 21 by detecting the light intensity. In one embodiment, the strength of the first light intensity and of the second light intensity can be saved in the parameter storage unit 43.

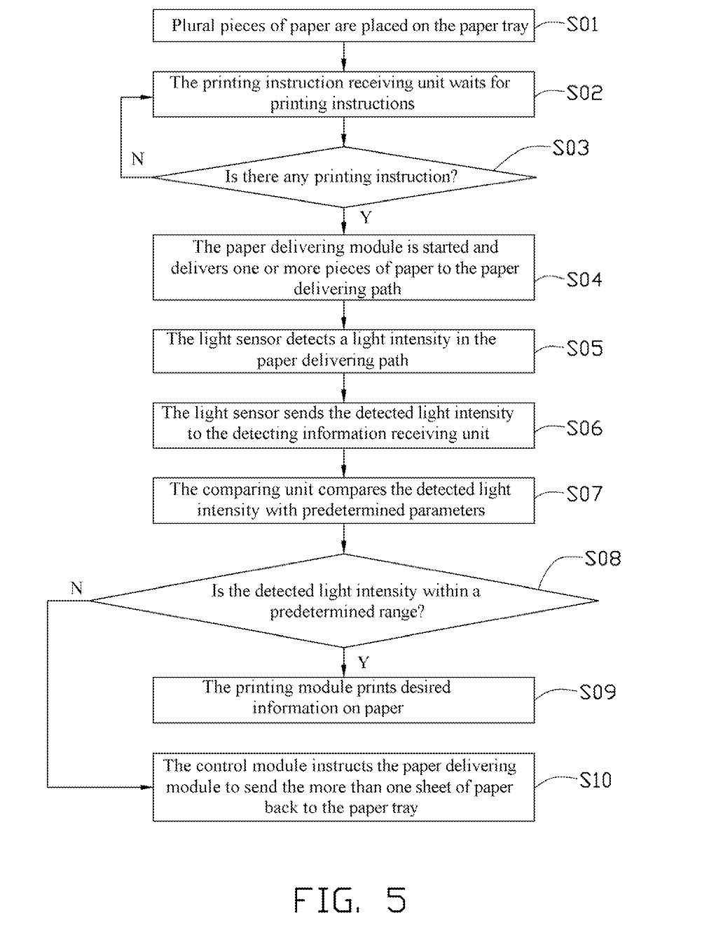

Referring to FIG. 5, a printing method, based upon one embodiment of the printing device 100, includes the following blocks.

In block S01, paper 60 is placed on the paper tray 30.

In block S02, the printing instruction receiving unit 41 is awaiting printing instructions sent from a request terminal.

In block S03, if there is a printing instruction, the process goes to block SO4, and if not, the process reverts to block S02.

In block S04, the instruction sending unit 45 sends an instruction to start the paper delivering module 20. The paper delivering module 20 functions by delivering the paper 60 one at a time to the paper delivering path 21.

In block S05, when an object comes between the light source 51 and the light sensor 53, the intensity of light emitted from the light source 51 and reaching the light sensor 53 changes. The light sensor 53 detects a new light intensity.

In block S06, the light sensor 53 sends information of the new light intensity to the detecting information receiving unit 42.

In block S07, the comparing unit 44 compares the new light intensity with parameters stored in the parameter storage unit 43.

In block S08, the control module 40 determines if the new light intensity is within a predetermined range. If so, it is determined that the light-blocking object is one sheet of paper and the process goes to block S09. If not within the range, it is determined that there is more than one sheet of paper entering the paper delivering path 21 and the process flows to block S10.

In block S09, the printing module 10 prints as requested.

In block S10, the instruction sending unit 45 sends an instruction to the paper delivering module 20 to reverse or pull back the more than one sheet of paper back into the paper tray 30. Users can detach any papers adhering together, and the print task can be requested again.

While the present disclosure has been illustrated by the description of preferred embodiments thereof, and while the preferred embodiments have been described in considerable detail, it is not intended to restrict or in any way limit the scope of the appended claims to such details. Additional advantages and modifications within the spirit and scope of the present disclosure will readily appear to those skilled in the art. Therefore, the present disclosure is not limited to the specific details and illustrative examples shown and described.

Depending on the embodiment, certain of the steps of methods described may be removed, others may be added, and the sequence of steps may be altered. It is also to be understood that the description and the claims drawn to a method may include some indication in reference to certain steps. However, any indication used is only to be viewed for identification purposes and not as a suggestion as to an order for the steps.

What is claimed is:

1. A printing device comprising:
a paper tray for supporting paper;
a paper delivering module comprising a paper delivering path connected to the paper tray for delivering the paper;
a control module connected to the paper delivering module, and configured to send instructions to control the paper delivering module;
a printing module configured to print information on one or more sheets of the paper; and
a detecting module connected to the control module and the paper delivering module, and configured to detect whether the paper delivering module delivers the paper one at a time and send detected information to the control module.

2. The printing device of claim 1, wherein the detecting module comprises a light sensor and a light source located at opposite sides of the paper delivering path, and the light sensor is configured to sense a light intensity in the paper delivering path.

3. The printing device of claim 2, wherein the control module includes a detecting information receiving unit configured to receive information of the light intensity detected by the light sensor.

4. The printing device of claim 3, wherein the control module further comprises a parameter storage unit and a comparing unit, the parameter storage unit is configured to store predetermined parameters, and the comparing unit is configured to compare the information of the light intensity detected by the light sensor with the predetermined parameters.

5. The printing device of claim 4, wherein the control module further comprises an instruction sending unit configured to send the instructions to the paper delivering module.

6. A printing method comprising:
placing paper on a paper tray of a printing device;
delivering the paper in a paper delivering path of the printing device;
determining if there is only one piece of paper entering the paper delivering path;
if there is only one piece of paper entering the paper delivering path, printing information on the one piece of paper; and
if there is more than one piece of paper entering the paper delivering path, sending back the more than one piece of paper to the paper tray.

7. The printing method of claim 6, further comprising providing a light source and a light sensor at opposite sides of the paper delivering path, wherein the light sensor senses a light intensity in the paper delivering path when one or more pieces of paper enters the paper delivering path.

8. The printing method of claim 7, further comprising comparing the light intensity detected by the light sensor with predetermined parameters stored in a parameter storage unit of the printing device.

9. The printed method of claim 8, wherein if the light intensity detected by the light sensor is in a predetermined range, then there is only one piece of the paper entering the paper delivering path; and if the light intensity detected by the light sensor is less than the predetermined range, then there is more than one piece of paper entering the paper delivering path.

10. The printing method of claim 8, further comprising detecting a first light intensity in the paper delivering path when there is no paper entering the paper delivering path and detecting a second light intensity in the paper delivering path when there is only one piece of paper entering the paper delivering path.

11. The printing method of claim 10, further comprising storing the first intensity and the second intensity in the parameter storage unit before the step of comparing the light intensity.
